(19) United States
(12) Patent Application Publication
(10) Pub. No.: US 2018/0050659 A1
(43) Pub. Date: Feb. 22, 2018

(54) ELECTRIC SEATBELT NOTIFICATION SYSTEMS AND METHODS

(71) Applicant: Faraday&Future Inc., Gardena, CA (US)

(72) Inventors: Matthew Joseph Coburn, Redondo Beach, CA (US); Chi Hung CAO, Huntington Beach, CA (US)

(73) Assignee: Faraday&Future Inc., Gardena, CA (US)

(21) Appl. No.: 15/242,735

(22) Filed: Aug. 22, 2016

(51) Int. Cl. B60R 22/48; B60R 21/0136; B60R 22/46

(52) U.S. Cl. CPC B60R 22/48; B60R 21/0136; B60R 2022/4685; B60R 2022/4866; B60R 2022/4666; B60R 22/46

(57) ABSTRACT

An electric seatbelt notification system may include an electric seatbelt configured to restrain the occupant in the vehicle, the electric seatbelt including one or more motors. The notification system may include a controller coupled to the electric seatbelt. The controller may be configured to detect a vehicle event and determine the tactual notification corresponding to the vehicle event. The controller may be further configured to generate a control signal to actuate the one or more motors of the electric seatbelt, and provide the tactual notification using the electric seatbelt to notify the occupant of the vehicle event. The tactual notification may be progressively stronger as the vehicle event persists.

### TECHNICAL FIELD

The present disclosure relates generally to a notification system for a vehicle, and more particularly, to an electric seatbelt notification system for a vehicle.

### BACKGROUND

Vehicles are generally equipped with several notification systems used to remind vehicle occupants about certain events or potential danger. For example, a low tone may be generated to remind the occupant that he hasn't fastened the seatbelt after departure. A series of beeps might be generated to notify a driver that an obstacle is detected and getting closer while backing. These notifications remind occupants to pay attention or react to potential events or danger and help improve car safety.

Some notification systems are installed in steering wheels in order to provide tactile notifications to drivers. These notification systems remind drivers through tactile actions of which some drivers, especially when tired, are easier to be aware. However, installation of these tactile notification systems in steering wheels is obstructive and requires additional components. Moreover, most steering wheels might not have enough space for such installation. It would be desirable to have a tactile notification system that is non-obstructive, available to all occupants, and minimizes the required installation.

The disclosed electric seatbelt notification system is directed to mitigating or overcoming one or more of the problems set forth above and/or other problems in the prior art.

### SUMMARY

One aspect of the present disclosure is directed to a notification system for providing a tactual notification to an occupant of a vehicle. The notification system may include an electric seatbelt configured to restrain the occupant in the vehicle, the electric seatbelt including one or more motors. The notification system may include a controller coupled to the electric seatbelt. The controller may be configured to detect a vehicle event and determine the tactual notification corresponding to the vehicle event. The controller may be further configured to generate a control signal to actuate one or more motors of the electric seatbelt, and provide the tactual notification using the electric seatbelt to notify the occupant of the vehicle event. The tactual notification may be progressively stronger as the vehicle event persists.

Another aspect of the present disclosure is directed to a method for providing a tactual notification to an occupant of a vehicle through an electric seatbelt. The method may include detecting a vehicle event and determining the tactual notification corresponding to the vehicle event. The method may further include generating a control signal to actuate one or more motors of the electric seatbelt, and providing the tactual notification using the electric seatbelt to notify the occupant of the vehicle event. The tactual notification may be progressively stronger as the vehicle event persists.

Yet another aspect of the present disclosure is directed to a non-transitory computer-readable medium storing instructions which, when executed, cause one or more processors to perform a method for providing a tactual notification to an occupant of a vehicle through an electric seatbelt. The method may include detecting a vehicle event and determining the tactual notification corresponding to the vehicle event. The method may further include generating a control signal to actuate one or more motors of the electric seatbelt, and providing the tactual notification using the electric seatbelt to notify the occupant of the vehicle event. The tactual notification may be progressively stronger as the vehicle event persists.

### BRIEF DESCRIPTION OF THE DRAWINGS

FIG. 1 is an illustration of an exemplary embodiment for the electric seatbelt notification system, consistent with the present disclosure.

FIG. 2 is a block diagram of an exemplary electric seatbelt notification system including an exemplary controller, consistent with the present disclosure.

FIG. 3 is a flow chart illustrating an exemplary method that may be performed by the controller of the electric seatbelt notification system of FIG. 2.

### DETAILED DESCRIPTION

The disclosure is generally directed to an electric seatbelt notification system that may increase car safety while minimizing the required installation. In some embodiments, the electric seatbelt notification system may include an electric seatbelt and a controller coupled to the electric seatbelt. The electric seatbelt may include one or more motors and may be configured to restrain the occupant in the vehicle. The controller may be configured to detect a vehicle event and determine the tactual notification corresponding to the vehicle event. The controller may be further configured to generate a control signal to actuate the one or more motors of the electric seatbelt, and provide the tactual notification using the electric seatbelt to notify the occupant of the vehicle event. The vehicle event may be a condition that requires the occupant's attention or action. For example, it may be a condition that requires the occupant to take control during semi-autonomous driving, a situation that the driver of the vehicle is fatigued, a finding that the vehicle is within threshold distance from another vehicle, or an instance that the vehicle moves into another lane. The vehicle event is not limited to a condition occurred to the vehicle. It may also include an event occurred to another device, such as a mobile phone, a tablet, a wearable device, or another personal device, of the occupant. In some embodiments, the tactual notification may be progressively stronger (e.g., with progressive force or progressive repetitions, or at increasing frequencies) as the vehicle event persists. The tactual notification may be provided in various ways and combinations. In some embodiments, the controller may be configured to provide the tactual notification by tapping the occupant (e.g., selectively tapping a shoulder or a hip of the occupant) by means of tightening and releasing the electric seatbelt. In some embodiments, the controller may be configured to provide the tactual notification by vibrating the electric seatbelt.

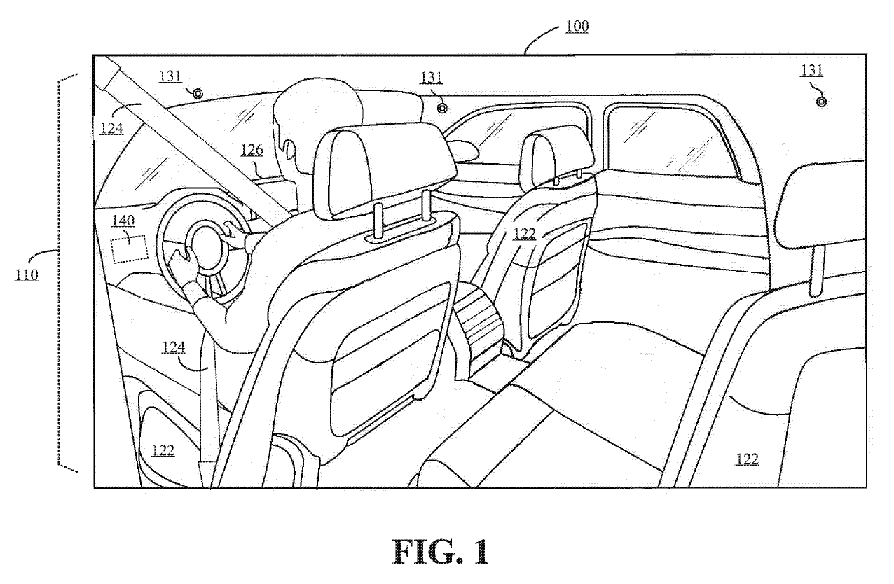

FIG. 1 is an illustration of an exemplary embodiment for an electric seatbelt notification system 110 consistent with the present disclosure. A vehicle 100 may have one of various body styles, such as a sports car, a coupe, a sedan, a pick-up truck, a station wagon, a sports utility vehicle (SUV), a minivan, or a conversion van. Vehicle 100 may be an electric vehicle, a fuel cell vehicle, a hybrid vehicle, or a conventional internal combustion engine vehicle. Vehicle 100 may be configured to be operated by a driver occupying vehicle 100, remotely controlled, and/or autonomously. As illustrated in FIG. 1, vehicle 100 may include a plurality of seats 122 that allow occupants to sit on with respective electric seatbelts 124 fastened. In FIG. 1, for example, an occupant may sit on a seat 122 with an electric seatbelt 124 fastened in vehicle 100.

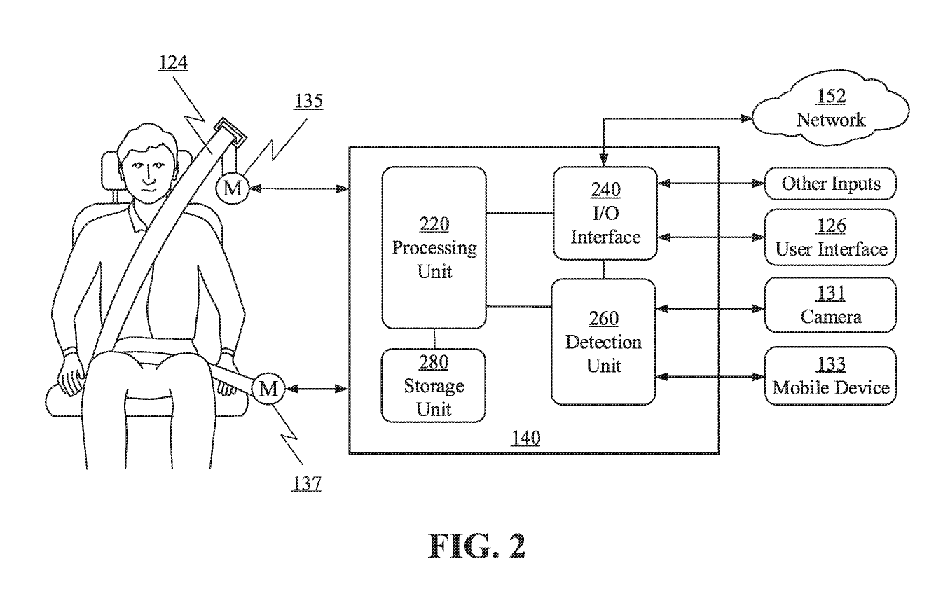

Vehicle 100 may include an electric seatbelt notification system 110 having an electric seatbelt 124 and a controller 140. Electric seatbelt 124 may include one or more motors 135, 137 (as depicted in FIG. 2) and may be configured to restrain occupants in vehicle 100. In some embodiments, controller 140 may be configured to detect a vehicle event. For example, controller 140 may be configured to detect whether the driver is fatigued by analyzing continuously captured images of the driver. When the driver's eyes are closed more frequently than before, controller 140 may detect driver fatigue.

Controller 140 may be further configured to determine the tactual notification corresponding to the vehicle event. For example, controller 140 may determine a series of taps as the tactual notification corresponding to the detected driver fatigue by using a look-up table.

Controller 140 may generate a control signal to actuate one or more motors 135, 137 of electric seatbelt 124. For example, controller 140 may be configured to generate a control signal to actuate motors 135, 137 to tap the occupant by tightening and releasing electric seatbelt 124 to tactually notify of a vehicle event. In some embodiment, the control signal may selectively actuate motor 135 to tap a shoulder of the occupant or actuate motor 137 to tap a hip of the occupant. In some embodiments, controller 140 may also be configured to generate a control signal to actuate one or more motors 135, 137 to vibrate electric seatbelt 124 to provide the tactual notification to the occupant.

The tactual notification may then be provided by electric seatbelt 124 to notify the occupant of the vehicle event. In some embodiments, controller 140 may be configured to generate a series of control signals to actuate one or more motors 135, 137 to provide progressively stronger tactual notification. For example, electric seatbelt 124 may be controlled to tap the occupant or vibrate with progressive force or progressive repetitions, or at increasing frequencies, as the vehicle event persists.

Vehicle 100 may also include a user interface 126. In some embodiments, user interface 126 may include a touch screen, a controller, and a plurality of input buttons (not shown). User interface 126 may be connected to electric seatbelt notification system 110 to display default setting of electric seatbelt notification system 110 and to allow users to change all or a part of these setting. For example, user interface 126 may display the default or current setting of electric seatbelt notification system 110 when the vehicle engine is started or when an occupant requests to display that by touching a button on the touch screen or pressing an input button. An occupant may be able to input his setting preference of electric seatbelt notification system 110 through user interface 126. In some embodiments, user interface 126 may also be configured to display a notification of a vehicle event supplementary to the tactual notification provided by electric seatbelt 124. The occupant may be able to touch the screen of user interface 126 or press a certain one or any of its input buttons to turn off the notification or to input his reaction to the notification. Controller 140 may be configured to receive these inputs from user interface 126 and react accordingly. Although user interface 126 is illustrated as located at the dashboard of vehicle 100, it is contemplated that user interface 126 may be located at other suitable places, such as on the back of front seats, on the sides of the vehicle, on a drop down projector, etc.

Vehicle 100 may further include a semi-autonomous driving system (not shown). In some embodiments, the semi-autonomous driving system may include a controller, a plurality of sensors, such as cameras, and distance detectors (not shown). The semi-autonomous driving system, for example, may be configured to provide lane keeping, emergency braking, or automatic parking. Its controller may be configured to perform these semi-autonomous driving functions based on received images from its cameras and/or received parameters from its distance detectors. When a condition that requires the occupant to take control occurs during semi-autonomous driving, the semi-autonomous driving system may send a signal to electric seatbelt notification system 110. Such a condition may be, for example, failure to detect a lane or unable to accomplish automatic parking. Controller 140 of electric seatbelt notification system 110 may be configured to provide a tactual notification to the occupant once it detects a condition that requires the occupant to take control during semi-autonomous driving.

Vehicle 100 may further include a driver fatigue detection function (not shown). In some embodiments, controller 140 may be further configured to detect that the driver of the vehicle is fatigued. Vehicle 100 may include a plurality of cameras 131 and sensors configured to acquire data of occupants. The data from cameras 131 and the sensors may be aggregated and processed according to software, algorithms, and/or look-up tables to determine conditions of occupants. For example, cameras 131 may acquire images of the driver and send to controller 140. Controller 140 may be configured to detect whether the driver is fatigued by analyzing these images of the driver. For example, the driver may be detected as fatigued when the driver's eyes are closed in a series of consecutive images or when the frequency of closed eyes of the driver increases in the received images of the driver. Controller 140 may determine the tactual notification corresponding to the driver fatigue, generate a control signal to actuate one or more motors 135, 137 of electric seatbelt 124, and provide the tactual notification using electric seatbelt 124 to notify the driver.

Vehicle 100 may further include a distance detection function (not shown). In some embodiments, controller 140 may be further configured to detect that the distance of the vehicle from another vehicle is within threshold distance. Vehicle 100 may include a plurality of cameras and distance sensors (not shown) at the exterior of the vehicle configured to acquire distance data of other vehicles. The distance data from the cameras and the distance sensors may be aggregated and processed according to software, algorithms, and/or look-up tables to determine the distance of the vehicle from another vehicle. For example, the cameras and the distance sensors may acquire images and distance data and send to controller 140. Controller 140 may be configured to detect whether the distance to another vehicle is within threshold distance by analyzing these images and distance data. For example, the distance to another vehicle in front of the vehicle may be detected as within threshold distance when the detected distance is smaller than a safe distance calculated according to the vehicle's speed. The distance to another vehicle at the left or right lane may be detected as within threshold distance when the detected distance is smaller than half the width of a lane. Controller 140 may then determine the tactual notification corresponding to the threshold distance, generate a control signal to actuate one or more motors 135, 137 of electric seatbelt 124, and provide the tactual notification using electric seatbelt 124 to notify the driver that the distance from another vehicle is within threshold distance

Vehicle 100 may further include a lane change detection function (not shown). In some embodiments, controller 140 may be further configured to detect that the vehicle moves into another lane. Vehicle 100 may include a plurality of cameras and sensors (not shown) at the exterior of the vehicle configured to trace position of the vehicle in a lane. The data from the cameras and the sensors may be aggregated and processed according to software, algorithms, and/or look-up tables to determine the lane the vehicle is in. For example, the cameras and the sensors may acquire images and position data and send to controller 140. Controller 140 may be configured to detect whether the vehicle is moving into another lane by analyzing these images and position data. For example, the vehicle is detected as being moving into another lane when the detected position of the vehicle to the boundary of the lane is smaller than 20 centimeters. Controller 140 may then determine the tactual notification corresponding to the lane change, generate a control signal to actuate one or more motors 135, 137 of electric seatbelt 124, and provide the tactual notification using electric seatbelt 124 to notify the driver that the vehicle is moving into another lane.

Vehicle 100 may also include a mobile device event detection function (not shown). In some embodiments, controller 140 may be further configured to detect an event occurred to a mobile device 133 (as depicted in FIG. 2) of an occupant. Vehicle 100 may be connected with mobile device 133 through various different networks. For example, mobile device 133 of an occupant may be able to connect to vehicle 100 through a wireless connection, such as Bluetooth, Wi-Fi, and cellular (e.g., GPRS, WCDMA, HSPA, LTE, or later generations of cellular communication systems) connection, or a wired connection, such as a USB line or a Lighting line. After connected, controller 140 may be configured to detect whether an event occurs to the occupant's mobile device 133. For example, such an event may include receiving a phone call, receiving an email, receiving a text or chat message, mobile device battery low, receiving a calendar invitation or reminder. Controller 140 may then determine the tactual notification corresponding to the detected mobile event, generate a control signal to actuate one or more motors 135, 137 of electric seatbelt 124, and provide the tactual notification using electric seatbelt 124 to notify the occupant that event occurred to his mobile device 133.

FIG. 2 is a block diagram of an exemplary electric seatbelt notification system 110 including an exemplary controller 140, consistent with the present disclosure. Controller 140 may be coupled to one or more motors 135, 137 of electric seatbelt 124 and controller 140 may send control signals to actuate one or more motors 135, 137 for tightening or releasing electric seatbelt 124. In response, motors 135, 137 may provide torque to a gear, engaging the belt spool and applying tension to electric seatbelt 124 or release it. Controller 140 may also receive and transmit signals from and to user interface 126 and other inputs for the purpose of displaying information, setting up user preference, or receiving input signals for detection of vehicle events. Controller 140 may also connected to network 152 to retrieve up-to-date information and system configuration, or to feedback user experience and preference to a central server of notification system. Network 152 may include a number of different types of networks enabling communication between controller 140 and a remote server (not shown). In some embodiments, network 152 may be a wired network, a local wireless network (e.g., Bluetooth™, WiFi, near field communications (NFC), etc.), a cellular network (e.g., GPRS, WCDMA, HSPA, and LTE), an Internet, or the like, or a combination thereof. Other known communication methods which provide a medium for transmitting data are also contemplated. Controller 140 may also receive and transmit signals from and to a plurality of cameras 131 and mobiles devices 133 of occupants in order to detect vehicle events.

As illustrated in FIG. 2, controller 140 may include a processing unit 220, an I/O interface 240, a detection unit 260, and a storage unit 280. One or more of the components of controller 140 may be included in an on-board computer of vehicle 100. These units may be configured to transfer data and send or receive instructions between or among each other.

Processing unit 220 may include an appropriate type of general-purpose or special-purpose microprocessor, digital signal processor, or microcontroller. Processing unit 220 may be configured to receive and process signals to determine a plurality of conditions of the operation of electric seatbelt notification system 110. Processing unit 220 may be configured to receive signals from detection unit 260 about detection of a vehicle event. Processing unit 220 may also be configured to determine the tactual notification corresponding to the detected vehicle event. Processing unit 220 may be configured to generate and transmit control signals to actuate motor 135 and/or motor 137 of electric seatbelt 124. Processing unit 220 may also be configured to provide the determined tactual notification using electric seatbelt 124 to notify the occupant of the detected vehicle event. In some embodiments, processing unit 220 may further be configured to provide progressively stronger tactual notification as the vehicle event persists. Processing unit 220 may also be configured to process input signals from I/O interface 240. For example, processing unit 220 may be configured to process and react to a user's input, via I/O interface 240, from user interface 126.

I/O interface 240 may also be configured for two-way communication between controller 140 and various input sources, such as user interface 126, a plurality of sensors, a plurality of detectors, and other inputs. I/O interface 240 may also send and receive operating signals to and from processing unit 220 and detection unit 260. For example, I/O interface 240 may be configured to send input signals from user interface 126 to processing unit 220 for further processing or reaction to an occupant's input. I/O interface 240 may also be configured to send input signals from sensors or detectors to detection unit 260 for detecting occurrence of potential vehicle events. I/O interface 240 may also be configured to send and receive data to and from network 152 for various purposes, such as storing user data remotely, downloading user data, downloading system configuration update, etc.

Detection unit 260 may include an appropriate type of hardware, such as integrated circuits and field programmable gate array, or software, such as a set of instructions, a subroutine, or a function (i.e. a functional program) executable on a processor or controller, to carry out detection function by, for example, comparing to existing patterns or thresholds of vehicle events. Detection unit 260 may be configured to perform event detection according to input data from cameras 131 and mobile devices 133, or other input data received from I/O interface 240. For example, detection unit 260 may be configured to detect a condition that requires the occupant to take control during semi-autonomous driving according to a signal, via I/O interface 240, from a semi-autonomous driving system. In some embodiments, detection unit 260 may be also configured to detect that the driver of the vehicle is fatigued according to images and data received from camera 131 and other sensors or inputs. In some embodiments, detection unit 260 may be further configured to detect that the distance of the vehicle from another vehicle is within threshold distance. In some embodiments, detection unit 260 may be further configured to detect that the vehicle moves to another lane. In some embodiments, detection unit 260 may be further configured to detect an event occurred to mobile device 133 of an occupant.

Storage unit 280 may include any types of memory devices or modules, such as registers in circuits, cache memories, random access memories (RAM), read only memories (ROM), disk memories, cloud memories, etc. Storage unit 280 may be configured to store default setting, user data and preference, notification parameters, etc. Storage unit 280 may also be configured to store any kind of data temporarily for processing unit 220, detection unit 260, or I/O interface 240.

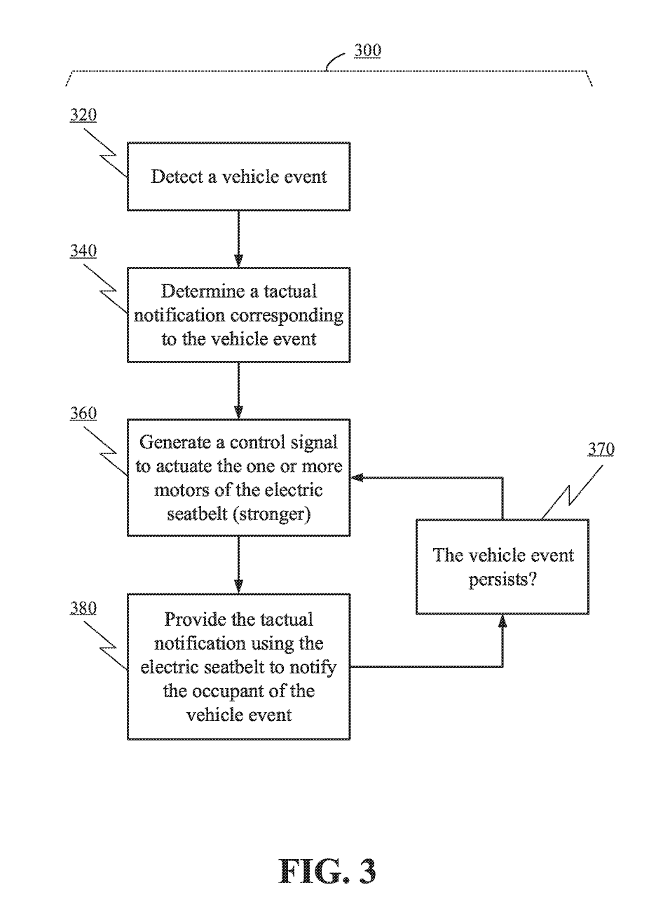

FIG. 3 provides a flow chart illustrating an exemplary method 300 that may be performed by controller 140 of FIG. 2.

Step 320 may include detecting a vehicle event. Detecting a vehicle event may include detecting, via input from I/O interface 240, a condition that requires the occupant to take control during semi-autonomous driving. For example, a semi-autonomous driving function may be configured to provide lane keeping, emergency braking, or automatic parking. These semi-autonomous driving functions may be configured to perform based on received images from its cameras and/or received parameters from its distance and position detectors. When a condition that requires the occupant, especially the driver, to take control occurs during semi-autonomous driving, the semi-autonomous driving system may send a signal, via I/O interface 240, to electric seatbelt notification system 110. The condition may be, for example, failure to detect a lane or unable to accomplish automatic parking. Step 320 may include detecting such a condition that requires the occupant to take control during semi-autonomous driving.

In some embodiments, detecting a vehicle event of step 320 may include detecting that the driver of the vehicle is fatigued according to images and data received from cameras 131, and other sensors and inputs. For example, the driver may be detected as fatigued when the driver's eyes are closed in a series of consecutive images or when the frequency of closed eyes of the driver increases in the received images of the driver.

In some embodiments, detecting a vehicle event of step 320 may include detecting that the distance of the vehicle from another vehicle is within threshold distance. For example, the distance to another vehicle in front of the vehicle may be detected as within threshold distance when the detected distance is smaller than a safe distance calculated according to the vehicle's speed. The distance to another vehicle at the left or right lane may be detected as within threshold distance when the detected distance is smaller than half the width of a lane.

In some embodiments, detecting a vehicle event of step 320 may include detecting that the vehicle moves into another lane. For example, the vehicle is detected as being moving into another lane when the detected distance of the vehicle to the boundary of the lane is smaller than 20 centimeters.

In some embodiments, detecting a vehicle event of step 320 may include detecting an event occurred to mobile device 133 of an occupant. For example, mobile device 133 of an occupant may be able to connect to vehicle 100 through wireless connection, such as Bluetooth, Wi-Fi, and cellular (e.g., GPRS, WCDMA, HSPA, LTE, or later generations of cellular communication systems) connection, and wired connection, such as a USB line or a Lighting line. After connected, detecting a vehicle event of step 320 may include detecting whether an event occurs to the occupant's mobile device 133.

Step 340 may include determining a tactual notification corresponding to the detected vehicle event in step 320. In some embodiments, determining a tactual notification corresponding to the detected vehicle event may include looking up an entry of the detected vehicle event in an event-notification mapping table and determining the tactual notification corresponding to the detected vehicle event according to the event-notification mapping table. In some embodiments, determining a tactual notification corresponding to the detected vehicle event may include adopting a default tactual notification as the determined tactual notification corresponding to the detected vehicle event when no entry in the event-notification mapping table could be found for the detected vehicle event. In some embodiments, the event-notification mapping table may be configured by an occupant through user interface 126. In some embodiments, the event-notification mapping table may be downloaded or updated from network 152.

Step 360 may include generating a control signal to actuate one or more motors 135, 137 of electric seatbelt 124. In some embodiments, generating a control signal may include generating a control signal to actuate one or more motors 135, 137 to tap the occupant by tightening and releasing electric seatbelt 124. In some embodiments, tapping the occupant may include tapping a shoulder of the occupant by generating a control signal to actuate only motor 135 to tighten and release electric seatbelt 124. In some embodiments, tapping the occupant may include tapping a hip of the occupant by generating a control signal to actuate only motor 137 to tighten and release electric seatbelt 124. In some embodiments, generating a control signal may include generating a control signal to actuate one or more motors 135, 137 to tighten and release electric seatbelt 124 as a series of taps designated to indicate the detected vehicle event. In some embodiments, generating a control signal may include generating a control signal to actuate one or more motors 135, 137 to vibrate electric seatbelt 124. In some embodiments, generating a control signal may include generating a control signal to actuate one or more motors 135, 137 to tighten and release electric seatbelt 124 with progressive force or progressive repetitions. In some embodiments, generating a control signal may include generating a control signal to actuate one or more motors 135, 137 to tighten and release electric seatbelt 124 at an increasing frequency. The one or more motors 135, 137 may be used to transfer electro-mechanical force to a mechanical force directed on the electric seatbelt.

Step 380 may include providing the determined tactual notification using electric seatbelt 124 to notify the occupant of the detected vehicle event. In some embodiments, providing the determined tactual notification may include providing progressive stronger determined tactual notification as the detected vehicle event persists. In some embodiments, providing the determined tactual notification may also include tapping the occupant by tightening and releasing electric seatbelt 124. In some embodiments, providing the determined tactual notification may also include selectively tapping a shoulder or a hip of the occupant. In some embodiments, providing the determined tactual notification may also include providing a series of taps designated to indicate the detected vehicle event. In some embodiments, providing the determined tactual notification may also include vibrating electric seatbelt 124. In some embodiments, providing the determined tactual notification may also include providing the determined tactual notification with progressive force or progressive repetitions from electric seatbelt 124. For example, the force of tapping the occupant may be doubled after every 5 times of taps, where forceful tapping may be carried out by increasing tightness of electric seatbelt 124. For another example, the series of taps may be repeated again after a shorter period than it was in the last time. In some embodiments, providing the determined tactual notification may also include providing the tactual notification at an increasing frequency. For example, the tapping frequency may be increased from 1 time per second to 2 times per second.

In some embodiments, the one or more motors 135, 137 may be a DC brush motor or DC brushless motor, which may be used to create the tactual notification. One or more DC brush or brushless motors may be operatively connected to an offset weight. The offset weight may cause the DC motor's shaft to become unbalanced and vibrate. The offset weight may be configured so that it impacts the electric seatbelt 124 at a regular interval when the DC brush or brushless motor is engaged. Alternatively, the DC brush or brushless motor's unbalanced shaft may itself impact the electric seatbelt at a regular interval. The impact of either the offset weight or unbalanced shaft on the electric seatbelt 124 may cause a corresponding tightening of the electric seatbelt 124 and thus a tightening force may be transmitted to a wearer of the electric seatbelt 124. Similarly, as the offset weight or unbalanced shaft is rotated so that it releases from the electric seatbelt 124, a corresponding relaxing of the electric seatbelt 124 may be caused and thus a releasing force may be transmitted to a wearer of the electric seatbelt 124.

In some embodiments, the one or more motors 135, 137 may be an actuator. The actuator is used to create a tactual notification. One or more actuators may be operatively connected to the electric seatbelt 124. The actuator may be a linear actuator or a rotational actuator. A linear actuator may be configured to create either a longitudinal or horizontal force on the electric seatbelt 124 such that the created force is transmitted to the wearer of the electric seatbelt 124. In some embodiments a linear actuator may be used to create a first force and a second force greater than the first force on the electric seatbelt 124. In other embodiments a rotational actuator may be used to create a sustained force on an electric seatbelt such that the sustained force may be transmitted to the wearer of electric seatbelt 124.

Step 370 may include deciding whether the detected vehicle event persists. After the determined tactual notification is provided to the occupant, detecting whether the detected vehicle event persists may include detecting a vehicle event after a suitable period of time. Once the same vehicle event is detected again, generating a control signal of step 360 may include generating a control signal to actuate one or more motors 135, 137 to provide progressively stronger tactual notification than that of the last time. A suitable period of time to detect again may be decided according to the property of the detected vehicle event. For example, a short period of time may be adopted in the vehicle event of driver fatigue. When an event occurred to a mobile device of an occupant is detected, the period of time to detect whether the vehicle event persists, for example, may be longer than that for the vehicle event of driver fatigue.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed remote control system and related methods. Other embodiments will be apparent to those skilled in the art from consideration of the specification and practice of the disclosed remote control system and related methods. It is intended that the specification and examples be considered as exemplary only, with a true scope being indicated by the following claims and their equivalents.

What is claimed is:

1. A notification system for providing a tactual notification to an occupant of a vehicle, the system comprising:
an electric seatbelt configured to restrain the occupant in the vehicle, the electric seatbelt comprising one or more motors;
a controller coupled to the electric seatbelt, configured to:
detect a vehicle event;
determine the tactual notification corresponding to the vehicle event;
generate a control signal to actuate the one or more motors of the electric seatbelt; and
provide the tactual notification using the electric seatbelt to notify the occupant of the vehicle event, wherein the tactual notification is progressively stronger as the vehicle event persists.

2. The notification system of claim 1, wherein the tactual notification includes tapping the occupant by tightening and releasing the electric seatbelt.

3. The notification system of claim 2, wherein the tactual notification includes selectively tapping a shoulder or a hip of the occupant.

4. The notification system of claim 2, wherein the tactual notification includes a sequence of taps designed to indicate the vehicle event.

5. The notification system of claim 1, wherein the tactual notification includes vibrating the electric seatbelt.

6. The notification system of claim 1, wherein the tactual notification is provided with progressive force or progressive repetitions from the electric seatbelt.

7. The notification system of claim 1, wherein the tactual notification is provided at an increasing frequency.

8. The notification system of claim 1, wherein detecting an event occurred to a mobile device of the occupant.

9. The notification system of claim 1, wherein detecting the vehicle event includes at least one of:
detecting a condition that requires the occupant to take control during semi-autonomous driving;
detecting that the driver of the vehicle is fatigued;
detecting that the vehicle is within threshold distance from another vehicle; and
detecting that the vehicle moves into another lane.

10. A method for providing a tactual notification to an occupant of a vehicle through an electric seatbelt, the method comprising:
detecting a vehicle event;
determining the tactual notification corresponding to the vehicle event;
generating a control signal to actuate one or more motors of the electric seatbelt; and
providing the tactual notification using the electric seatbelt to notify the occupant of the vehicle event, wherein the tactual notification is progressively stronger as the vehicle event persists.

11. The method of claim 10, wherein the tactual notification includes tapping the occupant by tightening and releasing the electric seatbelt.

12. The method of claim 11, wherein the tactual notification includes selectively tapping a shoulder or a hip of the occupant.

13. The method of claim 11, wherein the tactual notification includes a sequence of taps designed to indicate the vehicle event.

14. The method of claim 10,
wherein the tactual notification includes vibrating the electric seatbelt.

15. The method of claim 10, wherein the tactual notification is provided with progressive force or progressive repetitions from the electric seatbelt.

16. The method of claim 10, wherein the tactual notification is provided at an increasing frequency.

17. The method of claim 10, wherein detecting the vehicle event includes detecting an event occurred to a mobile device of the occupant.

18. The method of claim 10, wherein detecting the vehicle event includes at least one of:
detecting a condition that requires the occupant to take control during semi-autonomous driving;
detecting that the driver of the vehicle is fatigued;
detecting that the vehicle is within threshold distance from another vehicle; and
detecting that the vehicle moves into another lane.

19. A non-transitory computer-readable medium storing instructions which, when executed, cause one or more processors to perform a method for providing a tactual notification to an occupant of a vehicle through an electric seatbelt, the method comprising:
detecting a vehicle event;
determining the tactual notification corresponding to the vehicle event;
generating a control signal to actuate one or more motors of the electric seatbelt; and
providing the tactual notification using the electric seatbelt to notify the occupant of the vehicle event, wherein the tactual notification is progressively stronger as the vehicle event persists.

20. The non-transitory computer-readable medium of claim 19, wherein detecting the vehicle event includes at least one of:
detecting a condition that requires the occupant to take control during semi-autonomous driving;
detecting that the driver of the vehicle is fatigued;
detecting that the vehicle is within threshold distance from another vehicle; and
detecting that the vehicle moves into another lane.
